(19) United States
(12) Patent Application Publication
(10) Pub. No.: US 2004/0221970 A1
(43) Pub. Date: Nov. 11, 2004

(54) Window covering headrail having ornamental panel

(75) Inventor: Ming Nien, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Nien Made Enterprise Co., LTD., Taichung (TW)

(21) Appl. No.: 10/459,514

(22) Filed: Jun. 12, 2003

(30) Foreign Application Priority Data
May 6, 2003 (TW) 92208271

(51) Int. Cl. E06B 9/30

(52) U.S. Cl. 160/173 R

(57) ABSTRACT

A headrail for a window covering is constructed to include a base panel having a coupling groove longitudinally extended along a front long side thereof, two end caps respectively fastened to two distal ends of the base panel, and an ornamental panel. The coupling groove has a narrow top open width smaller than an inside width thereof. The ornamental panel has a top coupling flange curved from a top side thereof and defining with the ornamental panel a contained angle, and a top bearing portion formed of a bar protruded from the top coupling flange and engaged into the coupling groove of the base panel. The top bearing portion of the ornamental panel has a transverse width slightly smaller than the top open width of the coupling groove of the base panel.

### BACKGROUND OF THE INVENTION

1. Field of the Invention

The present invention relates generally to a window covering, such as a Venetian blind, roller blind, etc., and, more specifically, to a headrail for window covering, which has a detachable ornamental panel.

2. Description of the Related Art

For the purposes of decoration and dust protection, a headrail of a window covering, e.g. Venetian blind, roller blind, etc., may be covered with an ornamental panel. The ornamental panel is normally made detachable so that the user can remove the ornamental panel from the headrail for cleaning or repairing the inside structure of the headrail. The ornamental panel fastening devices are installed in the headrail horizontally. This installation method requires much operation space. Further, mounting or dismounting the ornamental panel requires a particular hand tool. For safety's sake, the headrail and the ornamental panel are assembled on the floor, and then installed in the top side of the window. Due to the aforesaid limitations, the mounting and dismounting of the ornamental panel are complicated.

### SUMMARY OF THE INVENTION

The present invention has been accomplished under the circumstances in view. It is the main object of the present invention to provide a headrail for window covering, which has a detachable ornamental panel.

It is another object of the present invention to provide a window covering headrail having an ornamental panel, which is easy to install.

To achieve these objects of the present invention, the headrail for a window covering comprises a base panel having a coupling groove longitudinally extended along a front long side thereof, two end caps respectively fastened to two distal ends of the base panel, and an ornamental panel. The coupling groove has a narrow top open width smaller than an inside width thereof. The ornamental panel has a top coupling flange curved from a top side thereof and defining with the ornamental panel a contained angle, and a top bearing portion formed of a bar protruded from the top coupling flange and engaged into the coupling groove of the base panel. The top bearing portion of the ornamental panel has a transverse width slightly smaller than the top open width of the coupling groove of the base panel.

### BRIEF DESCRIPTION OF THE DRAWINGS

FIG. 1 is perspective assembly view of the preferred embodiment of the present invention.

FIG. 2 is an exploded view of the headrail shown in FIG. 1.

FIG. 3 is a schematic drawing showing the installation action of the ornamental panel according to the present invention.

FIG. 4 is another schematic drawing showing the installation action of the ornamental panel according to the present invention.

FIG. 5 is still another schematic drawing showing the installation action of the ornamental panel according to the present invention.

### DETAILED DESCRIPTION OF THE INVENTION

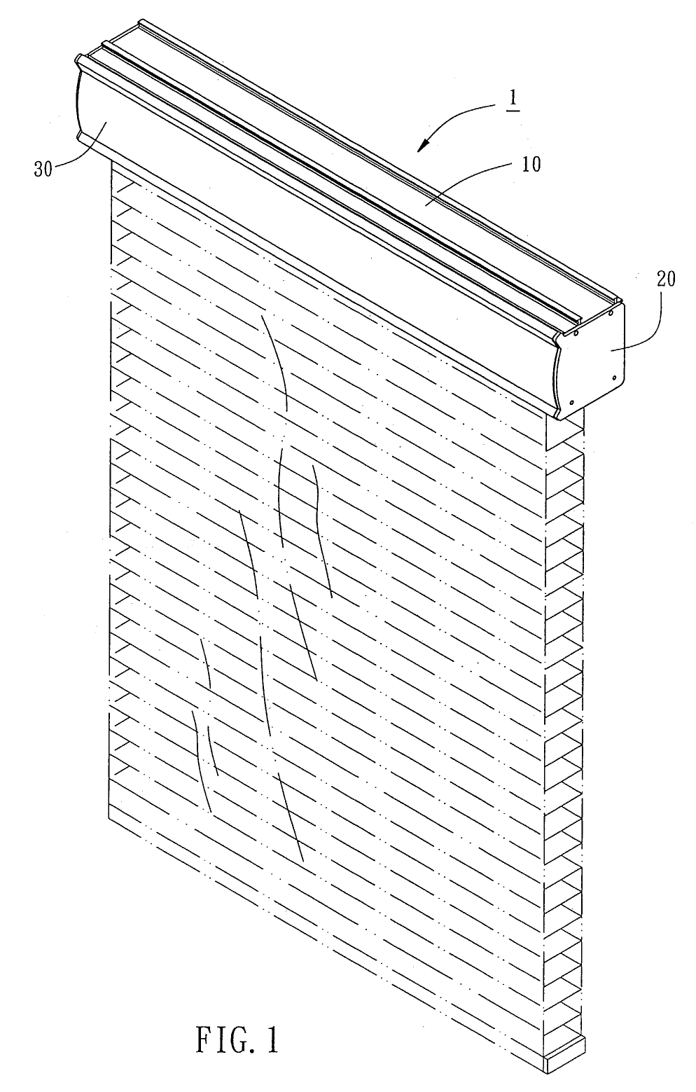

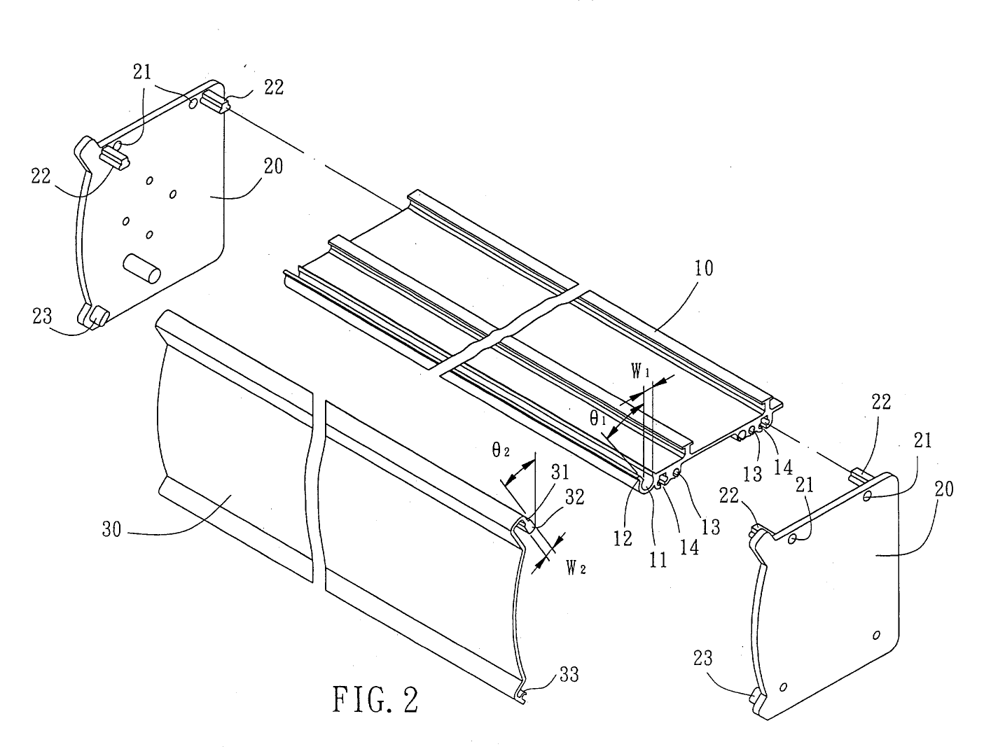

Referring to FIGS. 1 and 2, a headrail 1 for window covering in accordance with a preferred embodiment of the present invention is shown comprised of a base panel 10, two end caps 20, and an ornamental panel 30.

The base panel 10 is a rectangular plate member having a coupling groove 11, a bearing portion 12, two receivers 13, and two guides 14. The coupling groove 11 is formed in the top wall of the base panel 10 and extends longitudinally along one long side, namely, the front long side of the base panel 10, having a smoothly arched cross section and a top side. The width W1 of the top open side of the coupling groove 11 is smaller than the internal width of the coupling groove 11. The bearing portion 12 is formed of a rib longitudinally integrally extended along the outer side of the coupling groove 11 and defining with the normal axis of the base panel 10 a contained angle θ1 within about 25°˜45°, preferably at about 34°. The two receivers 13 each are comprised of two screw holes symmetrically located on the two distal ends of the base panel 10. The two guides 14 each are comprised of two guide holes symmetrically located on the two distal ends of the base panel 10.

The end caps 20 are flat rectangular caps symmetrically fastened to the two distal ends of the base panel 10 by screws, each comprises a mounting unit 21, a positioning unit 22, and a support unit 23. The mounting unit 21 is comprised of two through holes extended through the respective end cap 20 corresponding to the two screw holes (the receiver) 13 at one end of the base panel 10 for the mounting of screws to fixedly secure the respective end cap 20 to the base panel 10. The positioning unit 22 is comprised of two protruding rods respectively perpendicularly extended from the inner side of the respective end cap 20 and respectively plugged into the guide holes (the guide) 14 at one end of the base panel 10 to hold the through holes (mounting unit) 21 in alignment with the corresponding screw holes (the receiver) 13 for mounting. The support unit 23 is comprised of a protruding block of obliquely extended oval cross section perpendicularly extended from the inner side of the respective end cap 20.

The ornamental panel 30 is a narrow elongated transversely slightly arched plate member having a top coupling flange 31, a top bearing portion 32, and a bottom retaining flange 33. The top coupling flange 31 is curved from the top side of the ornamental panel 30, defining with the ornamental panel 30 a contained angle θ2 within about 25°˜45°, preferably at 34°. The top bearing portion 32 is shaped like a rectangular bar protruded from the top coupling flange 31. The transverse width W2 of the top bearing portion 32 is slightly smaller than the width W1 of the top open side of the coupling groove 11 of the base panel 10 so that the top bearing portion 32 of the ornamental panel 30 can be engaged into the coupling groove 11 of the base panel 10. The bottom retaining flange 33 is a hooked flange formed integral with the bottom side of the ornamental panel 30 fitting the support units 23 of the end caps 20.

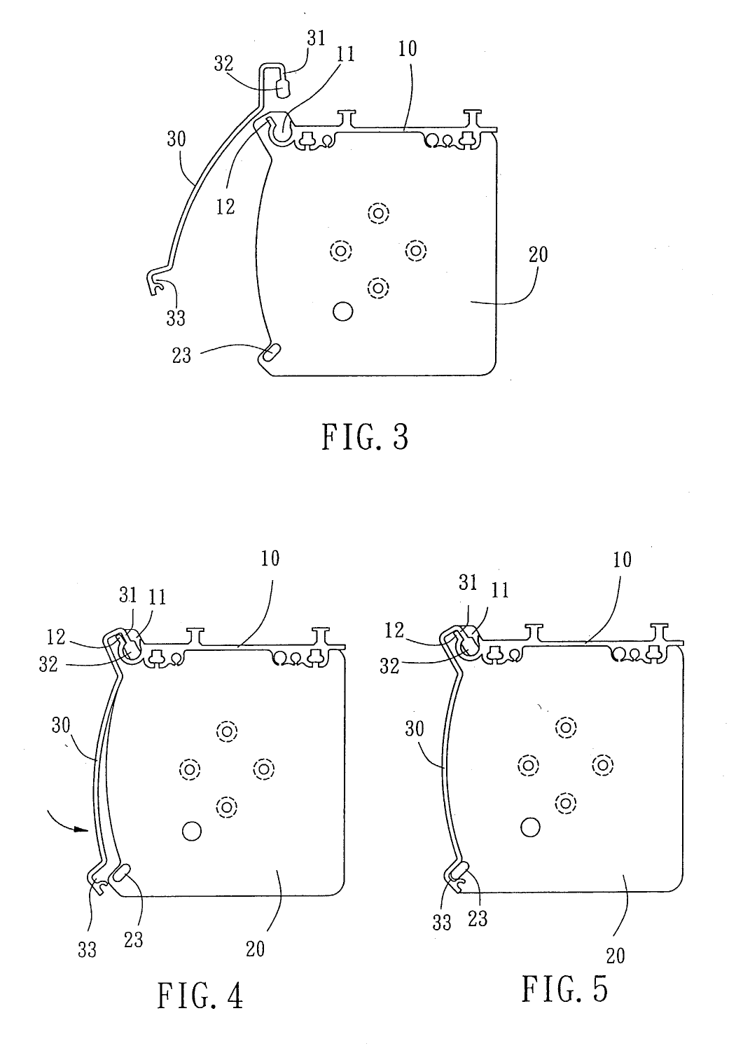

The aforesaid installation of the headrail 1 is outlined hereinafter with reference to FIGS. 3˜5. As indicated above, the transverse width W2 of the top bearing portion 32 is slightly smaller than the width W1 of the top open side of the coupling groove 11 of the base panel 10. During installation, the top bearing portion 32 of the ornamental panel 30 is vertically downwardly engaged into the coupling groove 11 of the base panel 10 (i.e., the ornamental panel 30 is inclined to an angle about 34° and then lowered to force the top bearing portion 32 into the coupling groove 11) as shown in FIG. 3, and then the ornamental panel 30 is forced by its gravity weight to turn downwards and to force the top bearing portion 32 into engagement with the bearing portion 12 of the base panel 10 as shown in FIG. 4, and then the ornamental panel 30 is forced toward the end caps 20, causing the bottom retaining flange 33 to hook on the support units 23 of the end caps 20 as shown in FIG. 5. When installed, the base panel 10 and the ornamental panel 30 are arranged at right angles. When removing the ornamental panel 30, repeat the aforesaid procedure reversely, i.e., disengage the bottom retaining flange 33 from the support units 23 of the end caps 20 at first, and then turn the ornamental panel 30 outwards from a substantially vertical position to an about 34° tilted position, and then lift the ornamental panel 30 to disengage the top bearing portion 32 from the coupling groove 11 of the base panel 10, and therefore the ornamental panel 30 is removed from the base panel 10.

As indicated above, the main features of the present invention are as follows:

1. By means of vertically engaging the top bearing portion 32 of the ornamental panel 30 into the coupling groove 11 of the base panel 10 to fasten the ornamental panel 30 to the base panel 10, the headrail 1 can be installed in a narrow place. Further, this design enables the user to detach the headrail 1 conveniently from the same position. Therefore, the mounting and dismounting procedures of the headrail 1 are easy.

2. By means of the engagement between the top coupling flange 31 and top bearing portion 32 of the ornamental panel 30 and the coupling groove 11 and bearing portion 12 of the base panel 10, the ornamental panel 30 is firmly secured to the base panel 10. When the distance between the top bearing portion 32 and bottom retaining flange 33 of the ornamental panel 30 made smaller than the distance between the coupling groove 11 of the base panel 10 and the support units 23 of the end caps 20, the connection between the base panel 10 and the ornamental panel 30 is enhanced. Further, in order to simplify the parts of the headrail, one of the end caps 20 or both the end caps 20 may be formed integral with the base panel 10. When one end cap 20 formed integral with the base panel 10, it becomes not detachable, however the installation of the headrail 1 becomes relatively easier.

What is claimed is:

1. A headrail for a window covering, comprising:
a base panel having a coupling groove formed in a top wall thereof and longitudinally extended along a long side thereof, said coupling groove having a top open side which has an open width smaller than an inside width of said coupling groove;
two end caps respectively fastened to two distal ends of said base panel; and
an ornamental panel having a top coupling flange curved from a top side thereof and defining with said ornamental panel a contained angle, and a top bearing portion formed of a bar protruded from said top coupling flange and engaged into the coupling groove of said base panel, the top bearing portion of said ornamental panel having a transverse width slightly smaller than the top open width of said coupling groove of said base panel.

2. The headrail as claimed in claim 1, wherein said end caps each comprise a support unit comprised of a protruding block extended from an inner side of the respective end cap; said ornamental panel comprises a retaining flange engaged with the support units of said end caps.

3. The headrail as claimed in claim 2, wherein said retaining flange of said ornamental panel is a hooked flange formed integral and curved from a bottom side of said ornamental panel.

4. The headrail as claimed in claim 2, wherein the distance between the top bearing portion and the bottom retaining flange of said ornamental panel is smaller than the distance between the coupling groove of said base panel and the support units of said end caps.

5. The headrail as claimed in claim 1, wherein said base panel further comprises a bearing portion formed of a rib longitudinally extended along an outer side of said coupling groove and defining with a normal axis of said base panel a contained angle.

6. The headrail as claimed in claim 5, wherein the contained angle defined between the bearing portion and the normal axis of said base panel is approximately equal to the contained angle defined between said top coupling flange and said ornamental panel.

7. The headrail as claimed in claim 6, wherein the contained angle defined between the bearing portion of said base panel and the normal axis of said base panel is within about 25°˜45°.

8. The headrail as claimed in claim 1, wherein said base panel comprises two receivers symmetrically disposed in two distal ends of said base panel, said receivers each comprised of two screw holes; said end caps each comprise a mounting unit formed of two through holes and respectively fastened to the screw holes of said receivers of said base panel by screws.

9. The headrail as claimed in claim 1, wherein said base panel comprises two guides symmetrically disposed in two distal ends of said base panel, said guides each comprised of two guide holes; said end caps each comprise a positioning unit formed of two protruding rods and respectively plugged into the guide holes of said guides of said base panel.

10. The headrail as claimed in claim 1, wherein said coupling groove of said base panel has a smoothly arched cross section.
